(19) United States
(12) Patent Application Publication
(10) Pub. No.: US 2013/0235736 A1
(43) Pub. Date: Sep. 12, 2013

(54) METHODS, SYSTEMS, AND COMPUTER READABLE MEDIA FOR TESTING A DIAMETER ROUTING NODE

(71) Applicant: TEKELEC, INC., Morrisville, NC (US)

(72) Inventors: Seetharaman Khadri, Cary, NC (US); Srikanth Nanjund Rao, Cary, NC (US); Peter J. Marsico, Chapel Hill, NC (US)

(73) Assignee: Tekelec, Inc., Morrisville, NC (US)

(21) Appl. No.: 13/659,522

(22) Filed: Oct. 24, 2012

Related U.S. Application Data
(60) Provisional application No. 61/550,901, filed on Oct. 24, 2011.

(51) Int. Cl. H04W 24/00

(52) U.S. Cl. CPC H04W 24/00
USPC 370/250

(57) ABSTRACT

According to one aspect, the subject matter described herein includes a method for testing a Diameter routing node. The method occurs a Diameter routing node. The method includes receiving, from a Diameter message generation module and via a test connection, a first Diameter message. The method also includes modifying the first Diameter message to include a test indicator parameter indicating the first Diameter message is a test message. The method further includes processing the first Diameter message. The method also includes directing the first Diameter message to an egress message manager.

### PRIORITY CLAIM

This application claims the benefit of U.S. Provisional Patent Application Ser. No. 61/550,901, filed Oct. 24, 2011, the disclosure of which is incorporated herein by reference in its entirety.

### TECHNICAL FIELD

The subject matter described herein relates to methods and systems for testing communications nodes. More particularly, the subject matter described herein relates to methods, systems, and computer readable media for testing a Diameter routing node.

### BACKGROUND

Diameter is an authentication, authorization and accounting (AAA) protocol for computer networks, and is a successor to Radius. The Diameter base protocol is defined in International Engineering Task Force (IETF) request for comments (RFC) 3588 which is incorporated by reference herein in its entirety. Diameter messages use a per user framework and exist in the format of request-answer messages. Diameter answer messages travel back to the request source via the same path through which the request message was routed using hop-by-hop transport.

Diameter messages may be exchanged between Diameter nodes for performing various functions. For example, a mobility management entity (MME) and a home subscriber server (HSS) may interact for authentication, authorization, and/or accounting (AAA) purposes. Since communications networks use Diameter messages to perform a variety of functions, it is important to make sure that Diameter nodes are working correctly and as expected.

Accordingly, there exists a need for methods, systems, and computer readable media for testing a Diameter routing node.

### SUMMARY

According to one aspect, the subject matter described herein includes a method for testing a Diameter routing node. The method occurs a Diameter routing node. The method includes receiving, from a Diameter message generation module and via a test connection, a first Diameter message. The method also includes modifying the first Diameter message to include a test indicator parameter indicating the first Diameter message is a test message. The method further includes processing the first Diameter message. The method also includes directing the first Diameter message to an egress message manager.

According to another aspect, the subject matter described herein includes a system for congestion management in a Diameter signaling network. The system includes a Diameter routing node. The Diameter routing node includes a connection module configured to receive, from a Diameter message generation module and via a test connection, a first Diameter message and to modify the first Diameter message to include a test indicator parameter indicating the first Diameter message is a test message. The Diameter routing node also includes a processing module configured to process the first Diameter message and to direct the first Diameter message to an egress message manager.

The subject matter described herein can be implemented in software in combination with hardware and/or firmware. For example, the subject matter described herein can be implemented in software executed by a processor. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

As used herein, the term “node” refers to a physical computing platform including one or more processors and memory.

As used herein, the terms “function” or “module” refer to software in combination with hardware and/or firmware for implementing features described herein.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a diagram illustrating connectivity between various nodes and a Diameter routing node according to an embodiment of the subject matter described herein;

FIG. 2 is a diagram illustrating an exemplary Diameter routing node according to an embodiment of the subject matter described herein;

FIG. 3 is a diagram illustrating exemplary processing of a Diameter message according to an embodiment of the subject matter described herein;

FIG. 4 is a diagram illustrating an exemplary log report according to an embodiment of the subject matter described herein; and

FIG. 5 is a flow chart illustrating an exemplary process for testing a Diameter routing node according to an embodiment of the subject matter described herein.

### DETAILED DESCRIPTION

In accordance with the subject matter disclosed herein, systems, methods, and computer readable media are provided for testing a Diameter routing node. Advantageously, aspects of the present subject matter described herein can be used for performing testing of a network node in a live network. For example, a DSR in accordance with aspects of the present subject matter described herein may allow an operator or a test module (e.g., a traffic generator) to send a Diameter Message via a test connection. After receiving the Diameter message via the test connection, the DSR may mark the Diameter message or otherwise identify the Diameter message as a test message. As the Diameter test message traverses the DSR, log messages may be generated at various points during processing (e.g., points may be designated in software and may be referred to as tracepoints). In some embodiments, the Diameter test message may include content or other information for determining various aspects of testing, such as which tracepoints generate or trigger log messages, which log messages are sent to a destination or stored, how the test message is processed, and/or whether the test message is sent to an egress destination or discarded. By differentiating between test messages and normal (e.g., non-test) messages, aspects of the subject matter described herein may be used to test a DSR that is concurrently routing normal Diameter traffic in a live network, e.g., without taking the DSR offline for testing.

Reference will now be made in detail to exemplary embodiments of the subject matter described herein, examples of which are illustrated in the accompanying drawings. Wherever possible, the same reference numbers will be used throughout the drawings to refer to the same or like parts.

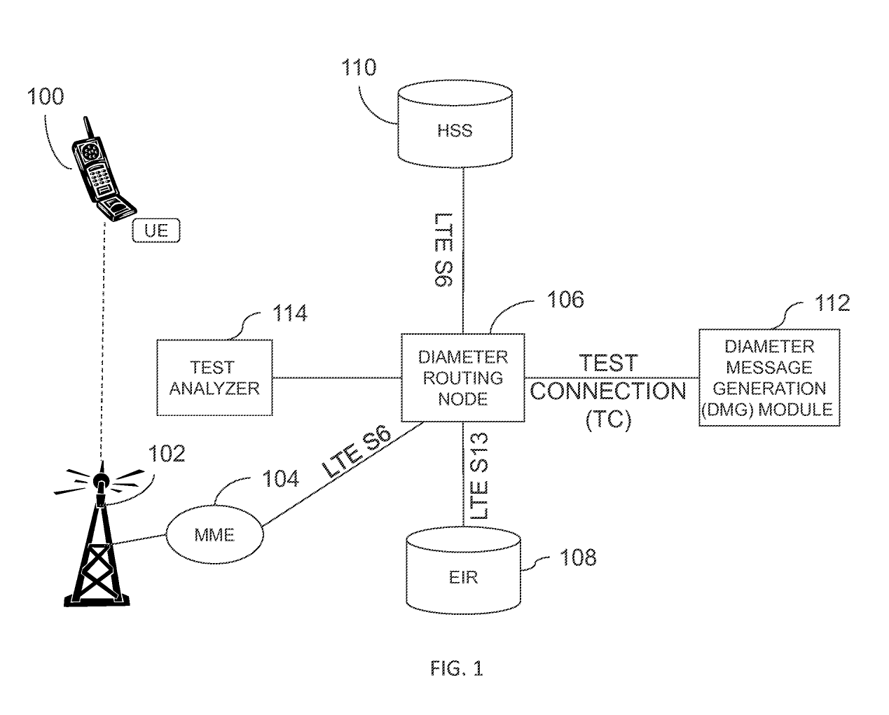

FIG. 1 is a diagram illustrating connectivity between various nodes and a Diameter routing node (also referred to herein as a Diameter router or a Diameter signaling router (DSR)) 106 according to an embodiment of the subject matter described herein. In the embodiment illustrated in FIG. 1, a communications network having user equipment (UE) 100, an ENode B 102 and various Diameter nodes, including DSR 106, a mobility management entity (MME) 104, a home subscriber server (HSS) 110 and an equipment identity register (EIR) 108, is depicted. Diameter nodes may be nodes capable of implementing or using a Diameter protocol. For example, Diameter nodes may include DSR 106, MME 104, HSS 110, an authentication, authorization, and accounting (AAA) server, a Bearer Binding and Event Reporting Function (BBERF), a serving gateway (SGW), a packet data network gateway (PDN GW), a charging data function (CDF), an online charging system, an offline charging system, a policy charging enforcement function (PCEF), a policy charging and rules function (PCRF), a subscriber profile repository (SPR), a Diameter agent, a network node, a policy engine, a policy server, an application function (AF), an application server, a Diameter signaling agent, a long term evolution (LTE) node, an Internet protocol (IP) multimedia subsystem (IMS) network node, a server, a correlation node, a node, a database, a signaling gateway, a gateway, a monitoring node, a Diameter message processor, a data collection platform, a multi-protocol signaling gateway, a multi-protocol signaling router, or a computing platform. Examples of DSR 106 include, but are not limited to, a Diameter routing node, a Diameter routing agent, a Diameter relay agent, a Diameter redirect agent, a Diameter translation agent, a Diameter proxy agent.

DSR 106 may include functionality for receiving, processing and/or routing various messages (e.g., protocol data units (PDUs)) and may include various communications interfaces for communication with Diameter nodes, e.g., 3rd Generation Partnership Project (3GPP) LTE communications interfaces and other (e.g., non-LTE) communications interfaces. In some embodiments, receiving, processing, and/or routing functionality may be included in one or more modules. For example, DSR 106 may include or have access to one or more modules for receiving Diameter signaling messages associated with multiple different Diameter signaling interfaces, e.g., S9, S6a, S11, Cx, and Dx.

In some embodiments, DSR 106 may receive Diameter messages via other Diameter interfaces. For example, DSR 106 may receive Diameter message via an LTE interface, an IMS interface, an IETF specification interface, a 3GPP specification interface, a Third Generation Partnership Project 2 (3GPP2) specification interface, a European Telecommunications Standards Institute (ETSI) specification interface, an International Telecommunications Union (ITU) specification interface, a PacketCable specification interface, a MultiService Forum (MSF) specification interface, an Sh interface, a Dx interface, a Ro interface, a Rf interface, an Sp interface, a Gx interface, a Rx interface, a Gz interface, a Gy interface, a Gq interface, a Zh interface, a Dz interface, a Zn interface, a Ty interface, a Tx interface, a Dw interface, a Wa interface, a Wd interface, a Wx interface, a Wm interface, a Wg interface, a Pr interface, a Gr interface, a Gr+ interface, a Gi interface, a Wo interface, a Wf interface, a Re interface, an S6 interface, an S2 interface, an SW interface, an Sta interface, an S7 interface, an H2 interface, an E2 interface, an E4 interface, an E5 interface, a A3 interface, a A4 interface, a Rr interface, a Gq′ interface, a TC-6 interface, a TC-7 interface, a TC-8 interface, a TC-9 interface, a TC-10 interface, a TC-11 interface, a DB-0 interface, a DB-2 interface, a BI-1 interface, a LOC-1 interface, an Rw interface, a Pkt-mm-2 interface, a P-CSCF-PAM interface, a Pkt-laes-2 interface, an MM10 interface, an MZ interface, a Gmb interface, or a Zn′ interface.

In some embodiments, DSR 106 may include functionality for communicating with a Diameter message generation (DMG) module 112. DMG module 112 may be any suitable entity (e.g., software executing on a processor) for generating and sending Diameter messages. For example, DMG module 112 may be any message generation platform, such as a computing device running Seagull software or a multi-protocol traffic generator node. In some embodiments, DMG module 112 may generate and send Diameter messages in response to a test connection between DSR 106 and DMG module 112. For example, a network operator may configure a test connection through the use of a graphical user interface (GUI). Using configuration information, DSR 106 or another module may establish a test connection with DMG module 112 via various interfaces, such as one or more LTE interfaces mentioned above.

In some embodiments, DSR 106 may include functionality for testing one or more processing features associated with DSR 106. For example, DSR 106 may include a Diameter mediation feature for diagnosing or testing mediation rules before they are subjected to live traffic in the network. When testing mediation processing or another type of processing, DSR 106 may log rules applied, actions taken, and/or other diagnostics information associated with a test message injected into the system. DSR 106 may also provide or make accessible reports based on these log messages to one or more modules or nodes, such as test analyzer 114.

In some embodiments, DSR 106 and/or modules therein may include functionality for logging or collecting information associated with the handling of a Diameter message. For example, DSR 106 and/or modules therein may include software code (e.g., tracepoints) that when reached (e.g., executed) generate or trigger log messages or other data collection mechanisms. In some embodiments, tracepoints or information to be collected may be selected or preconfigured based on various factors, such as resource availability, a test type, or user configuration. In some embodiments, various modules and/or nodes (e.g., test analyzer 114) may access and use the collected information for various purposes, such as whether to introduce new firewall or mediation rules or to determine whether a harmonization policy is ready for deployment in a live network.

In some embodiments, DSR 106 may be configured to allow testing during normal or live traffic conditions: For example, DSR 106 may perform testing, including logging of test-related information, while also routing or processing Diameter messages associated with Diameter peer nodes and/or UE 102. DSR 106 may include an “auto stop” feature for stopping or pausing testing associated with Diameter processing. An “auto stop” feature may be usable for stopping or pausing a diagnose mode or a test mode, e.g., after a configured number of Diameter messages is received via the test connection or when resources utilization for normal traffic reaches a certain threshold. DSR 106 may include an “auto start” feature for restarting or un-pausing a diagnose mode or test mode, e.g., when resources utilization for normal traffic goes below a certain threshold.

In some embodiments, DSR 106, or a module therein, may maintain a PDU count parameter for each test connection. At an initial time (e.g., when a testing period starts), the PDU count parameter for a test connection may be set at a maximum value. When a Diameter message is received via the test connection, the Diameter message (e.g., PDU) may be modified to include a test indicator parameter and the PDU count may be decremented. When a PDU count reaches zero, the testing period may end, e.g., no more Diameter messages associated with the testing period may be processed.

In some embodiments, DSR 106, or a module therein, may maintain a maximum test PDUs parameter. A maximum test PDUs parameter may be a system wide parameter and may indicate the maximum number of Diameter messages (e.g., PDUs) allowed via a test connection for every testing period (e.g., test run). In some embodiments, the parameter may be preconfigured or may be based on available resources associated with DSR 106 or test system.

In some embodiments, DSR 106, or a module therein, may maintain a maximum test connections parameter. A maximum test connections parameter may be a system wide parameter and may indicate the maximum number of test connections that can be configured in the system. In some embodiments, the parameter may be preconfigured or may be based on available resources associated with DSR 106 or test system.

In some embodiments, DSR 106, or a module therein, may maintain a maximum simultaneous test connections parameter. A maximum simultaneous test connections parameter may be a system wide parameter and may indicate the maximum number of connections number of connections that can be in test mode simultaneously. In some embodiments, the parameter may be preconfigured or may be based on available resources associated with DSR 106 or test system.

In some embodiments, DSR 106 may be configured to prevent or prohibit traffic arriving on normal connections (e.g., non-test connections) from being transmitted via a test connection or to a test-related destination. For example, a Diameter message received from MME 104 having an intended destination associated with a test egress connection may be discarded. DSR 106 may also be configured to prevent or prohibit traffic arriving on test connections from being transmitted via a normal connection or to a non-test-related destination. For example, a Diameter message received from DMG module 112 with an intended destination of HSS 110 may be discarded.

In some embodiments, DSR 106 may include functionality for communicating with a test analyzer 114. Test analyzer 114 may be any suitable entity (e.g., software executing on a processor, a server, or other node or module) for configuring tests, initiating tests and/or analyzing tests results. For example, test analyzer 114 may be an operations, administration, and management (OAM) node or other network node. In some embodiments, test analyzer 114 may trigger or schedule tests and/or may analyze test-related information. For example, test analyzer 114 may communicate via a GUI and a HTTP and/or SOAP protocol to configure a DSR 106. In this example, the GUI may be used to configure various attributes (e.g., a maximum test connection parameter and a maximum PDUs parameter) or data associated with test connections and/or testing periods. In another example, test analyzer 114 may request and/or access diagnostic log reports associated with one or more testing periods. Test analyzer 114 may communicate with DSR 106, DMG module 112, and/or other nodes or modules via various interfaces, such as an LTE interface, a SOAP interface, and/or an HTTP interface.

While FIG. 1 depicts DSR 106 communicating with (e.g., receiving Diameter messages from) various Diameter nodes via particular Diameter interfaces, it will be appreciated that DSR 106 may communicate with the nodes depicted and other nodes via additional and/or different interfaces.

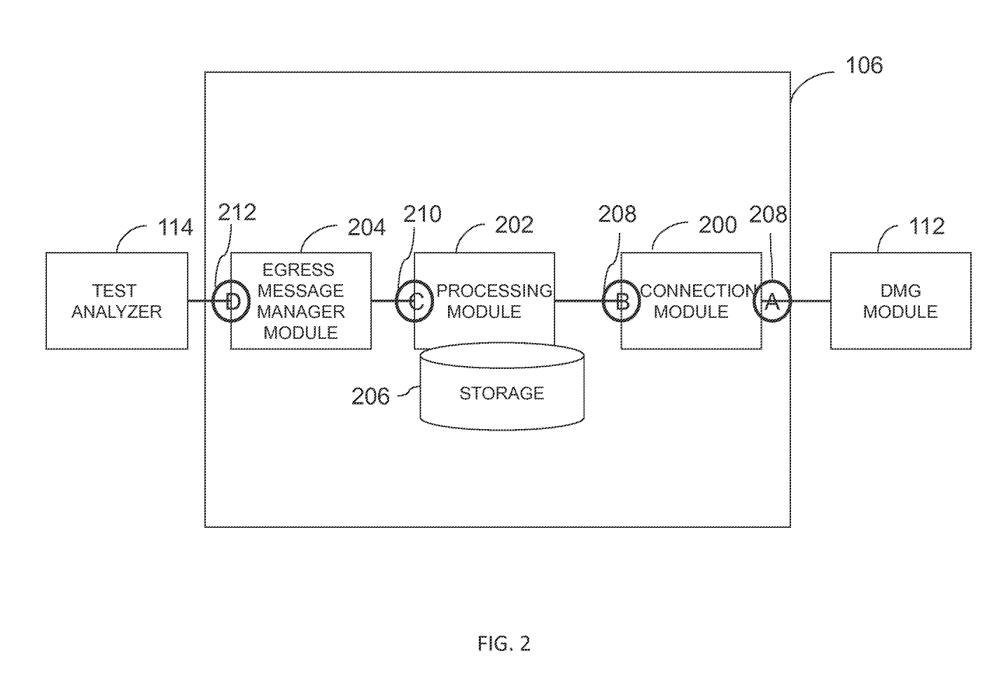

FIG. 2 is a diagram illustrating an exemplary DSR 106 according to an embodiment of the subject matter described herein. In the embodiment illustrated in FIG. 2, DSR 106 may include a connection module 200, a processing module 202, an egress message manager module (EMMM) 204, and storage 206. In some embodiments, DSR 106, or a module therein, may include one or more message processors (MPs). Each MP may include functionality for receiving, copying, processing, and/or sending Diameter messages. For example, connection module 200, processing module 202, and/or EMMM 204 may be associated with an MP that interfaces with DMG module 112 and/or test analyzer 114. In another example, connection module 200 and processing module 202 may be associated with one MP that interfaces with DMG module 112 and EMMM 204 may be associated with another MP that interfaces with test analyzer 114.

Referring to FIG. 2, connection module 200 may be any suitable entity for communicating with DMG module 112. For example, connection module 200 may include an ingress interface and functionality for setting up a test connection between DSR 106 and DMG module 112. Connection module 112 may also be configured to receive Diameter messages from DMG module 112 and/or other nodes or modules. For example, communication module 112 may be configured to receive Diameter messages from Diameter peer nodes. The Diameter messages from Diameter peer nodes may be live traffic (e.g., non-test messages) associated with UE 102 (e.g., a smartphone, a tablet computer, or other computing device of a mobile subscriber).

In some embodiments, connection module 200 or another module may be configured to mark or otherwise identify Diameter messages received via a test connection and/or from DMG module 112. For example, a received Diameter message (e.g., from DMG module 112) may be modified to include a test indicator parameter. A test indicator parameter may include any information for indicating that a Diameter message is a test message. In some embodiments, a test indicator parameter may be a number, character, or text. For example, a Diameter message may be modified to include or set a test message flag in a header of the Diameter message. In another example, in response to receiving a Diameter message via a test connection and/or from DMG module 112, information identifying the message as a test message may be stored in memory (e.g., storage 206). In this example, memory may be accessible by various modules, such as processing module 202 and EMMM 204. Once marked or identified as a test message, a Diameter message may be treated as such by DSR 106 and/or modules therein. In some embodiments, a Diameter test message may be treated differently from a normal Diameter message. For example, a Diameter message that has been modified to include a test message flag may be internally routed to processing module 202 and/or modules within DSR 106, but not routed to an egress destination that is distinct from DSR 106 like some normal Diameter messages. In some embodiments, a Diameter test message may receive different, additional, or the same processing as a normal Diameter message. For example, a Diameter test message may have both production mediation rules applied and test mediation rules applied, while normal or live Diameter messages may only have production mediation rules applied.

Processing module 202 may be any suitable entity (e.g., software executing on a MP) for processing Diameter messages and/or collecting information associated with processing a Diameter test message. Exemplary processing performed by processing module 202 may include firewall filtering, Diameter message mediation, Diameter protocol harmonization, and answer message generation. In an firewall filtering example, a Diameter test message may be subjected to one or more firewall filtering rules to determine the effect of the firewall filtering rules on the Diameter test message. In a protocol harmonization example, a Diameter test message may be modified according to a different version or release of the Diameter protocol associated with an intended egress destination. In an answer message generation example, a Diameter test message may trigger the generation of a Diameter answer message, which may also include a test indicator parameter (e.g., test message flag). The Diameter answer message with the test indicator parameter may be sent to an egress interface or EMMM 204.

EMMM 204 may be any suitable entity for communicating with test analyzer 114 or another node or module. For example, EMMM 204 may include an egress interface and functionality for setting up a test or non-test connection between DSR 106 and test analyzer 114. EMMM 204 may also be configured to send Diameter messages and/or test-related information (e.g., logs reports stored in storage 206) to test analyzer 114 and/or other nodes or modules.

In some embodiments, EMMM 204 may inspect or examine received Diameter messages. For example, EMMM 204 may examine a received Diameter message for a test indicator parameter. In another example, EMMM 204 may examine a header portion of a Diameter message for determining an intended origination and/or destination of the Diameter message. After inspecting the Diameter message and/or gathering other information (e.g., logged information from storage 206), EMMM 204 may perform one or more actions Exemplary actions performed by EMMM 204 may include discarding a message, directing a message to test analyzer 114 or another node or module, and/or logging some or all information contained in a message.

In some embodiments, EMMM 204 or another module may determine whether to direct a Diameter message to an egress connection (e.g., associated with an egress destination) or whether to discard the Diameter message based on whether a Diameter message is a test message and/or whether an intended destination of the Diameter message is an acceptable destination. For example, a Diameter test message associated with a test-related destination (e.g., test analyzer 114) may be sent or directed to the test-related destination. In another example, a Diameter test message that is associated with a non-test-related destination (e.g., a Diameter peer node) may be discarded. In yet another example where processing results in the generation of an associated Diameter Answer message or other message, similar actions may be taken.

Storage 206 may include any suitable entity (e.g., a computer readable medium) for maintaining or storing log messages, or portions thereof, and/or other test-related information. DSR 106 and/or other modules or nodes may access storage 206 for obtaining log reports, log messages, or other stored information. In some embodiments, storage 206 may be integrated with DSR 106 or one or more modules therein. In some embodiments, storage 206 may be distinct from and/or external to DSR 106.

Tracepoints A-D 208-214 may represent tracepoints or triggers for generating log messages. For example, a log message may be generated and stored in storage 206 in response to a Diameter message arriving or leaving modules within DSR 106. In some embodiments, a log message may include information about a Diameter message and related processing information. For example, a log message associated with tracepoint A 208 may include a timestamp, a tracepoint identifier, and a description indicating that a Diameter message having a PDU identifier of ‘242’ was received from DMG 112. In another example, a log message associated with tracepoint D 214 may include a timestamp, tracepoint identifier, a description indicating that a Diameter message having a PDU identifier of 242’ was received at EMMM 204 but an egress connection could not be determined for the Diameter message and, as such, the Diameter message was discarded.

While FIG. 2 depicts various modules within DSR 106, it will be appreciated that DSR 106 may include fewer, additional, or different modules and/or components. Further, each module depicted in FIG. 2 may include fewer, additional, or different modules and/or components. For example, connection module 200 and EMMM 204 may be integrated into a communications module.

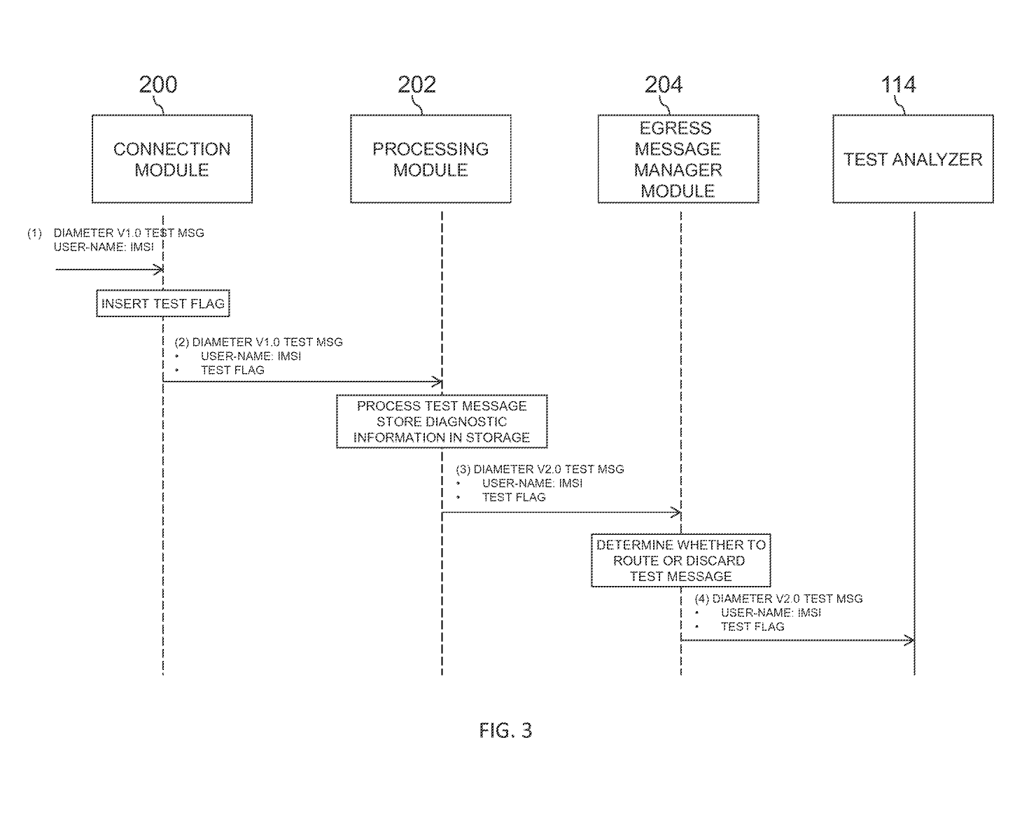

FIG. 3 is a diagram illustrating exemplary processing of Diameter test message according to an embodiment of the subject matter described herein. In some embodiments, the Diameter test message may be a Diameter message or PDU associated with a test connection and/or from a DMG module 112. For example, prior to step 1 of FIG. 3, a test connection may be established between connection module 200 and DMG module 112. In this example, the test connection may be a transport connection initiated or established by one or more messages that include a transport connection attribute (e.g., a test connection flag) for indicating that the transport connection is a test connection.

In some embodiments, a network operator or a module (e.g., test analyzer 114) may configure a test connection or attributes associated with a test connection via a GUI or other interface. For example, a transport connection table stored in storage 206 may be modified to include information about a test connection, such as time and/or date of test connection, protocol and/or interface used for connection, and/or other information. DSR 106 may use the transport connection table to establish a test connection for receiving one or Diameter test messages.

At step 1, a Diameter test message may be received at connection module 200. The Diameter test message may be associated with a particular protocol or Diameter version designated as version 1.0. The Diameter test message may include various attribute value pairs (AVPs), including an AVP containing an international mobile subscriber identity (IMSI).

Connection module 200 may modify the received Diameter test message to include a test message parameter or flag. The test message flag may be a bit or other parameter and may be accessible by other modules and/or node. After modifying the Diameter message to include a test message flag, the Diameter message may be sent to processing module 202.

At step 2, the Diameter message including the test message flag may be received at processing module 202. Processing module 202 may examine the Diameter message and determine that the Diameter message is a test message. Processing module 202 may process the Diameter message as a test message. For example, processing the Diameter test message may include performing Diameter harmonization such that the Diameter message is converted into a different protocol or format. In another example, processing the Diameter test message may include applying mediation or filter rules.

In some embodiments, processing module 202 may use information in the Diameter message and/or preconfigured information (e.g., in storage 206) to determine testing procedures and/or conditions. For example, certain Diameter messages may be associated with different tracepoints (e.g., points during processing). At each tracepoint, information about the Diameter message and related processing information may be collected. For example, at each tracepoint, one or more log messages including diagnostic or test-related information may be generated sent to storage 206. The collected information may be stored in storage 206 and/or correlated for log reports.

At step 3, the Diameter message or another Diameter message based on the Diameter message may be received by EMMM 204. The received Diameter message may be associated with a particular protocol or Diameter version designated as version 2.0. EMMM 204 may examine the received Diameter message and determine that the Diameter message is a test message. EMMM 204 may also determine an intended destination for the received Diameter message. In response to determining that the Diameter message is a test message and/or determining an intended destination is associated with test analyzer 114, EMMM 204 may determine that the received Diameter message is to be routed to test analyzer 114.

In some embodiments, EMMM 204 may discard the received Diameter message. For example, EMMM 204 may receive and discard one or more Diameter message associated with a particular testing period. In some embodiments, EMMM 204 or another module may send a log report to test analyzer 114 or another destination. In some embodiments, log reports may be sent or requested periodically (e.g., at intervals during the testing period) or aperiodically (e.g., dynamically).

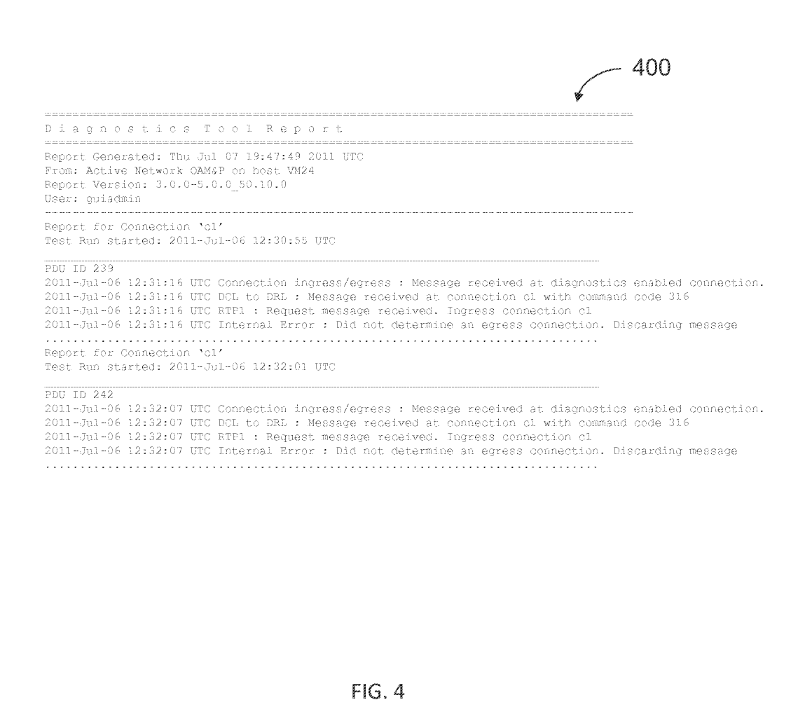

FIG. 4 is a diagram illustrating an exemplary log report 400 according to an embodiment of the subject matter described herein. As stated above, DSR 106 may include functionality (e.g., an application programming interface) for configuring and performing various test-related features, such as creating test connections, starting or stopping testing, and/or selecting and generating log reports for various test runs.

In some embodiments, DSR 106 may store test-related information, such as log messages or information from log messages, in storage 206. For example, log messages associated with one or more testing periods may be stored in a log table, database or data structure.

As depicted in Table 1 (shown below), an exemplary log table may include numerous columns or fields. For example, each log table entry may include an attribute name, a data type, a description, and a value. An attribute name field may be usable for identifying an attribute associated with a testing period, a Diameter message, or a parameter associated with DSR 106. For example, a valid attribute name may include a timestamp, a PDU identifier (ID), a connection ID, a tracepoint ID, a message description, or a received message ID. A data type field may be useable for identifying a type of data associated with the attribute. For example, a valid data type may include a time, an integer, an integer having 64 bits, a string, or a custom type. A description field may be usable for describing the attribute or information stored. A value field may be useable for storing the value or information associated with the attribute. Additional information regarding an exemplary log table may be found in Table 1 below.

TABLE 1
Log Table

| Attribute | | | |
|---|---|---|---|
| Name | Data Type | Description | Value |
| timestamp | Time | The time when the log was | 2011/11/03 |
| | | generated. | 02:34:43 |
| PDU ID | Integer | The identifier of an incoming | 344164 |
| | (64bits) | message. | |
| Connection | Integer | The identifier of an incoming | 23 |
| ID | | connection | |
| Tracepoint | Integer | The identifier of the tracepoint.. | 2 |
| ID | | | |
| Message | String | The log message that can hold | Success |
| Description | | up to 1024 characters. | |
| Received | Custom | This field stores the incoming | 344164/ |
| Message ID | | and/or outgoing PDU captured | 346465 |
| | | at the indicated tracepoint. | |

In some embodiments, a log table may be used in generating exemplary log report 400. For example, test analyzer 114 may request a report regarding a particular testing period from DSR 106 or a module therein. Exemplary log report 400 may be formatted and/or include information based on various factors, such as preference of requesting entity, a test type, length of testing period, or current resource utilization at DSR 106.

In some embodiments, exemplary log report 400 may include a timestamp indicating when the report was generated, information indicating which node generated the report, a report version, and a user identifier indicating who requested the report. Exemplary log report 400 may also include one or more testing periods for one or more test connections. For example, in exemplary report 400, two test periods or test runs via connection ‘C1’ are reported. Each test run may include one or more Diameter messages. For example, in exemplary report 400, each run includes a PDU and various log messages associated with the PDU. Each log message may include a timestamp and a description. For example, a log message may indicate progress of a PDU (e.g., Diameter message) traversing DSR 106. For example, in exemplary report 400, log messages for each test run indicate that each PDU is received, progresses through various processing points, and is discarded when no egress connection is determined.

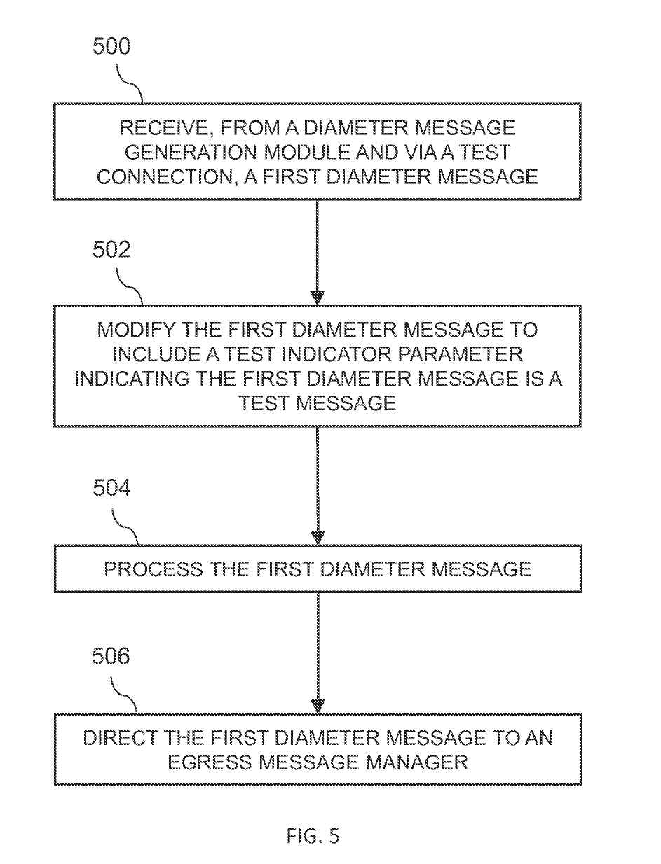

FIG. 5 is a flow chart illustrating an exemplary process for testing a Diameter routing node according to an embodiment of the subject matter described herein. In some embodiments, the exemplary process described herein, or portions thereof, may be performed at or performed by DSR 106, connection module 200, processing module 202, EMMM 204 and/or another module or node.

Referring to the embodiment illustrated in FIG. 5, at step 500, a first Diameter message may be received from a Diameter message generation module and via a test connection. For example, a Diameter message may be received by a connection module 200 from DMG module 112.

In some embodiments, the test connection may be associated with a long term evolution (LTE) interface, such as a LTE S1 interface.

In some embodiments, the Diameter message generation module may include a Diameter test message generator module or a Diameter peer node.

At step 502, the first Diameter message may be modified to include a test indicator parameter indicating the first Diameter message is a test message. For example, the test indicator parameter may be a flag, bit, or other information stored in the first Diameter message.

At step 504, the first Diameter message may be processed. For example, the first Diameter message may have firewall filtering rules or mediation rules applied. In this example, the rules applied may be different than rules applied to normal (e.g., non-test) Diameter messages.

In some embodiments, processing the first Diameter message may include adding information to, deleting information from, or modifying information contained in the first Diameter message.

In some embodiments, processing the first Diameter message may include generating a second Diameter message associated with the first Diameter message. In some embodiments, the second Diameter message may include a test indicator parameter indicating the second Diameter message is a test message. In some embodiments, the second Diameter message may be directed to the egress message manager.

At step 506, the first Diameter message may be directed to an egress message manager. For example, the first Diameter message may be sent to EMMM 204 for further processing.

In some embodiments, egress message manager (e.g., EMMM 204) may determine whether the first Diameter message is destined for a non-test-related destination. For example, in response to determining the first Diameter message is destined for test-related destination, the first Diameter message or information associated with the first Diameter message may be sent to the test-related destination. In another example, in response to determining the first Diameter message is not destined for a test-related destination, the first Diameter message may be prevented from reaching a destination that is not a test-related destination (e.g., the first Diameter message may be discarded).

In some embodiments, the egress message manager may be configured to extract information from the first Diameter message, discard the first Diameter message, and/or provide the extracted information (e.g., in a second Diameter message) to the test-related destination.

In some embodiments, the test-related destination may be a test analyzer node, an OAM node, and/or DMG module 112

It will be understood that various details of the subject matter described herein may be changed without departing from the scope of the subject matter described herein. Furthermore, the foregoing description is for the purpose of illustration only, and not for the purpose of limitation.

What is claimed is:

1. A method for testing a Diameter routing node, the method comprising:
at a Diameter routing node:
receiving, from a Diameter message generation module and via a test connection, a first Diameter message;
modifying the first Diameter message to include a test indicator parameter indicating the first Diameter message is a test message;
processing the first Diameter message; and
directing the first Diameter message to an egress message manager.

2. The method of claim 1 comprising:
determining, at the egress message manager, whether the first Diameter message is destined for a non-test-related destination;
in response to determining the first Diameter message is destined for test-related destination, sending the first Diameter message or information associated with the first Diameter message to the test-related destination; and
in response to determining the first Diameter message is not destined for a test-related destination, preventing the first Diameter message from reaching a destination that is not a test-related destination.

3. The method of claim 2 wherein sending the first Diameter message or information associated with the first Diameter message to the test-related destination includes extracting information from the first Diameter message, discarding the first Diameter message, and providing the extracted information to the test-related destination.

4. The method of claim 2 wherein the test-related destination is a test analyzer node, an operations, administration, and management (OAM) node, or the Diameter message generation module.

5. The method of claim 1 wherein the Diameter routing node comprises a Diameter signaling router (DSR).

6. The method of claim 1 wherein the test connection is associated with a long term evolution (LTE) interface.

7. The method of claim 1 wherein the Diameter message generation module includes a Diameter test message generator module or a Diameter peer node.

8. The method of claim 1 wherein processing the first Diameter message includes adding information to, deleting information from, or modifying information contained in the first Diameter message.

9. The method of claim 1 wherein processing the first Diameter message includes generating a second Diameter message associated with the first Diameter message.

10. The method of claim 9 wherein the second Diameter message includes a test indicator parameter indicating the second Diameter message is a test message.

11. The method of claim 10 wherein the second Diameter message is directed to the egress message manager.

12. A system for testing a Diameter routing node, the system comprising:
a Diameter routing node, the Diameter routing node comprising:
a connection module configured to receive, from a Diameter message generation module and via a test connection, a first Diameter message and to modify the first Diameter message to include a test indicator parameter indicating the first Diameter message is a test message; and
a processing module configured to process the first Diameter message and to direct the first Diameter message to an egress message manager.

13. The system of claim 12 wherein the egress message manager is configured to determine whether the first Diameter message is destined for a non-test-related destination, in response to determining the first Diameter message is destined for test-related destination, to send the first Diameter message or information associated with the first Diameter message to the test-related destination, and in response to determining the first Diameter message is not destined for a test-related destination, to prevent the first Diameter message from reaching a destination that is not a test-related destination.

14. The system of claim 13 wherein the egress message manager is configured to extract information from the first Diameter message, discard the first Diameter message, and provide the extracted information to the test-related destination.

15. The system of claim 13 wherein the test-related destination is a test analyzer node, an operations, administration, and management (OAM) node, or the Diameter message generation module.

16. The method of claim 1 wherein the Diameter routing node comprises a Diameter signaling router (DSR).

17. The system of claim 12 wherein the test connection is associated with a long term evolution (LTE) interface.

18. The system of claim 12 wherein the Diameter message generation module includes a Diameter test message generator module or a Diameter peer node.

19. The system of claim 12 wherein the processing module is configured to add information to, delete information from, or modify information contained in the first Diameter message.

20. The system of claim 12 wherein the processing module is configured to generate a second Diameter message associated with the first Diameter message.

21. The system of claim 20 wherein the second Diameter message includes a test indicator parameter indicating the second Diameter message is a test message.

22. The system of claim 21 wherein the processing module is configured to direct the second Diameter message to the egress message manager.

23. A non-transitory computer readable medium having stored thereon executable instructions that when executed by the processor of a computer control the computer to perform steps comprising:
receiving, from a Diameter message generation module and via a test connection, a first Diameter message;
modifying the first Diameter message to include a test indicator parameter indicating the first Diameter message is a test message;
processing the first Diameter message; and
directing the first Diameter message to an egress message manager.
